(19) United States
(12) Patent Application Publication
(10) Pub. No.: US 2025/0137836 A1
(43) Pub. Date: May 1, 2025

(54) MODULAR BLAST PROBE

(71) Applicants: BLACKBOX BIOMETRICS, INC., Rochester, NY (US); THE CURATORS OF THE UNIVERSITY OF MISSOURI, Columbia, MO (US)

(72) Inventors: Phillip Russell Mulligan, Rolla, MO (US); Angela D'Orazio, Rochester, NY (US); David A. Borkholder, Rochester, NY (US); Jeffrey Paul Heniff, Rolla, MO (US)

(21) Appl. No.: 18/713,587

(22) PCT Filed: Nov. 30, 2022
(86) PCT No.: PCT/US2022/051438

§ 371 Date: May 24, 2024

Related U.S. Application Data
(60) Provisional application No. 63/284,755, filed on Dec. 1, 2021.

(51) Int. Cl. G01H 3/12

(52) U.S. Cl. CPC G01H 3/12

(57) ABSTRACT

Systems and methods are disclosed including a modular blast probe comprising a reusable housing and a custom insert configured to engage and position a top surface of a respective one of a plurality of blast gauges or sensing elements substantially flush with an outer surface of the reusable housing.

### CLAIM OF PRIORITY

This application claims the benefit of priority under 35 U.S.C. § 119(e) of U.S. Provisional Patent Application Ser. No. 63/284,755, filed on Dec. 1, 2021, which is herein incorporated by reference in its entirety.

### TECHNICAL FIELD

This document relates generally to detecting exposure of blast events, and more particularly, but not by way of limitation, to a modular blast probe to position a top surface of a blast gauge at an outer surface of the modular blast probe.

### BACKGROUND

Unwanted or excessive sound can have deleterious effects on human health. Sounds having sound pressure levels (SPLs) above 85 decibels (dB) for extended periods of time can damage structures of the inner ear, leading to noise-induced hearing loss (NIHL). The Occupational Safety and Health Administration (OSHA) requires the employers implement hearing conservation programs when noise exposure is at or above 85 decibels averaged over 8 working hours, or an 8-hour time-weighted average (TWA). Exposure to sound events at more than 105 dB average (dBA) can cause some amount of permanent hearing loss.

Exposure to impulse events, such as blast exposure, can produce high intensity overexposures, often referred to as blast overpressure (BOP), which can pose both a risk of NIHL and a risk of traumatic brain injury (TBI) with one or more cumulative exposures. Impulse events include impulse noise events, such as gunshots, explosions, or other sound events having fast initial rise times, such as 50 μs or less (e.g., frequencies of 20 kHz or higher), often with SPLs above 140 dB (depending on distance from the event).

Blast sensors include one or more stationary or ambulatory sensors (e.g., each including one or more pressure, acoustic, or other sensing element) configured to detect and monitor exposure to impulse noise or shock wave events. Blast sensors can be worn by a person to monitor impulse noise or shock wave event exposure of the person or attached to one or more objects (e.g., protective equipment, accessories, stationary objects, vehicles, etc.) to monitor impulse noise or shock wave event exposure to people or associated with or near the one or more objects. Common measurements for an event include peak overpressure, the maximum force experienced for the event, as well as overpressure impulse, the total (e.g., time integrated) force experienced for the event, and such forces experienced depend at least in part on orientation of the sensor to the event, whether parallel to (e.g., incident), perpendicular with (e.g., reflected), or combinations thereof.

Blast sensors must be tested before use in the field, for efficacy in various conditions, but also for calibration. Such sensors are traditionally calibrated against a co-located sensing element in a pencil probe, or a “lollipop” probe. Whereas a pencil probe is commonly used to measure incident overpressure, the larger top surface area of the “lollipop” probe is useful for also being able to measure reflected overpressure, such as by changing the orientation of the probe from parallel with to perpendicular to the source. However, aligning sensors for testing can be difficult, as variance in position or placement can impact sensing performance with respect to specific events. The present inventors have recognized a need for improved testing of blast sensors in finished, packaged form, and not merely the sensing elements themselves separate from the finished blast sensors, such as taught by the prior art.

### SUMMARY

Systems and methods to position and retain a top surface of a housing of a first blast gauge substantially flush with an outer surface of a reusable housing of a modular blast probe using a first insert are disclosed. A modular blast probe can include a reusable housing having a cavity and an outer surface to provide a wave-shaping function and a first insert configured for placement in the cavity of the reusable housing. The cavity of the reusable housing can be configured to receive and retain the first insert. The first insert can include an interior surface configured to engage and position a top surface of a housing of a first blast gauge substantially flush with an outer top surface of the first insert. The outer top surface of the first insert, when positioned into and retained in the cavity of the reusable housing, can be substantially flush with the outer surface of the reusable housing, such as for data collection or measurement of one or more blasts proximate to the modular blast probe.

This summary is intended to provide an overview of subject matter of the present patent application. It is not intended to provide an exclusive or exhaustive explanation of the disclosure. The detailed description is included to provide further information about the present patent application. Other aspects of the disclosure will be apparent to persons skilled in the art upon reading and understanding the following detailed description and viewing the drawings that form a part thereof, each of which are not to be taken in a limiting sense.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIGS. 1-2 illustrate example first and second blast gauges.

FIGS. 3A-3C illustrate different views of a first modular blast probe.

FIGS. 4A-4E illustrate different schematic views of a reflected plate.

FIGS. 5A-5E illustrate example schematic views of a base mount.

FIGS. 6A-6G illustrate different views of a second modular blast probe.

FIGS. 7A-7B illustrate example top and side views of the first modular blast probe in operation.

FIGS. 8A-8C illustrate example views of example custom inserts.

### DETAILED DESCRIPTION

The present inventors have recognized, among other things, a modular blast probe with a reusable exterior body and a custom insert configured to receive and position for testing a variety of different blast gauges or sensors, such as in finished, packaged form.

Prior art pencil probes have a relatively standard smaller size, with a tapered, “pencil” end opposite a second end comprising a connector, with a body between the first and second ends carrying a sensing element. The size of the body is generally commensurate to the dimensions of the connector, such as a BNC connector (typically 0.57 inches in diameter). In testing, the pencil end is pointed at the source of a test blast wave (e.g., a test explosion, etc.). The sensing element is tested in the prior art pencil probe alone, absent any finished product or housing that may eventually hold or contain the sensing element. The size of the sensing element tested is limited by the size of the body and is generally smaller than the connector. In one example, a width of the body is 0.87 inches, not substantially larger than the size of the sensing element itself.

Prior art lollipop probes comprise a flat sensing surface having a relatively small diameter (about 2.5 inches), thickness (about 0.25 inches), a tapered edge, an arm extending away from the flat sensing surface by a distance (e.g., 4.5 inches), and a connector (e.g., a BNC connector) opposite the flat sensing surface on the arm. Like in the prior art pencil probe, a round sensing element (e.g., a quartz piezoelectric sensing element) is located in a drilled hole matching the size of the sensing element in the flat sensing surface.

The present inventors have recognized, among other things, that due to the size of the prior art pencil and lollipop probes, fully formed and packaged blast sensors having electronics and housings cannot be tested in the prior art pencil and lollipop probes, but merely the sensing elements themselves separate from the packaged products. Testing packaged blast sensors generally requires placing the packaged blast sensors in a position proximate a representative sensor in a prior art pencil or lollipop probe incident a test blast and comparing data from each. However, reproducibility of the position and alignment of the packaged products and the prior art pencil or lollipop probes can be difficult and time consuming, as minor variations in placement or position of the individual sensors can impact test results, and additionally, introduce interference or interaction between the multiple components and their individual and combined interactions with the test wave.

In addition, the size of the existing prior art pencil and lollipop probes cannot merely be increased, as the art does not teach a way to hold or contain the packaged blast sensors in an accurate and reproducible way without harming the packaged products. Additionally, one time-consuming and expensive part to manufacture is the housing of the blast probe, generally manufactured from a single piece of metal, such as steel or aluminum, although in other examples molded or machined from plastic, etc. Accordingly, it would be advantageous to have a reusable modular blast probe configured to securely, accurately, and reproducibly test different finished products, such as variations during design or of different models prior to implementation in the field, without requiring additional confirmation or alignment and positioning with the prior art pencil and lollipop probes, and without requiring separate manufacturing of the metal portion of the blast probe for each variation.

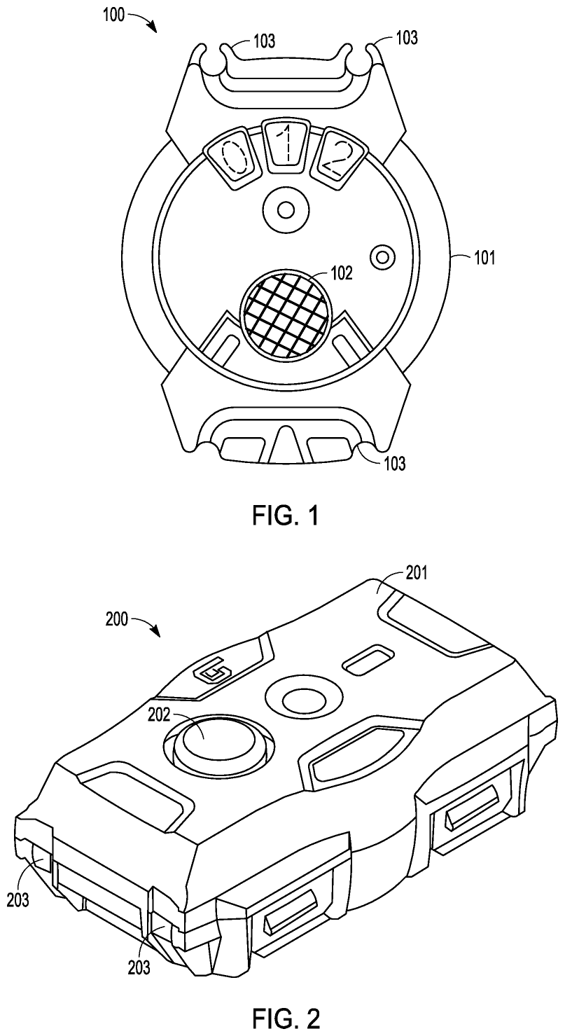

FIGS. 1 and 2 illustrate example first and second blast gauges 100, 200 in finished, packaged form, each including a respective blast gauge housing 101, 201 (e.g., having volumes of approximately 2 cubic inches or less) containing a sensing element proximate a top opening covered by a sensor cover 102, 202, one or more indicator lights, attachment features 103, 203, electronic circuitry, such as measurement circuits to measure one or more pressure signals, etc., communication circuits (e.g., wired or wireless communication circuits) for communication with one or more other devices, power management circuits, etc., a power source in the blast gauge housings 101, 201, etc.

To test different blast gauges, such as those illustrated in FIGS. 1 and 2 or otherwise, the present inventors have recognized that a blast probe can be manufactured having a relatively larger reusable housing with a cavity configured to receive and retain an insert designed to position and secure one or more specific blast gauges, and accordingly, sensing elements, in a desired position with respect to an outer surface of the housing of the blast probe. The housing can be composed of a metal (e.g., aluminum, steel, etc.) or harder outer surface, capable of surface finishing to reduce surface variations and accordingly interference of test blasts and configured for use in proximity to multiple, repeated test blasts and re-use over a longer period of time (e.g., months, years, etc.) with multiple inserts and blast gauges or other equipment. The shape or profile of the outer surface of the housing is configured to provide wave-shaping functions, minimizing or controlling the influence of the tested blast gauges and blast gauge housings on test blast wave propagation. In other examples, the housing can be composed of a glass-filed nylon or other plastic, include a 3D printed housing, etc.

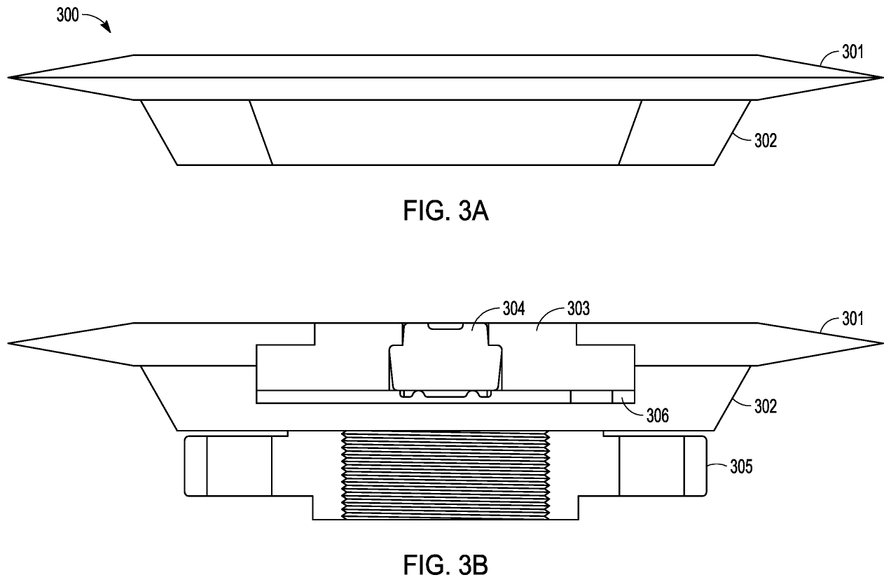

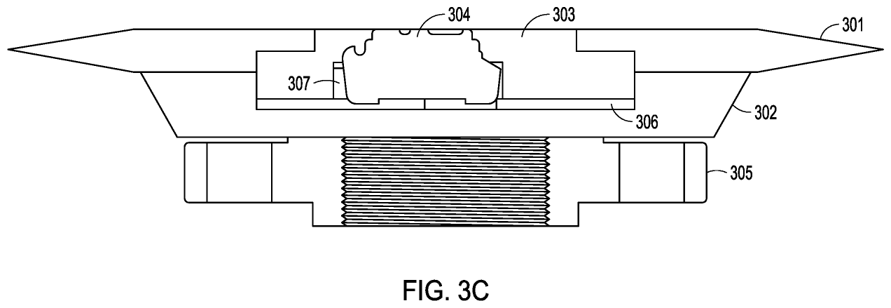

FIGS. 3A-3C illustrate different views of a first modular blast probe 300 in a “lollipop” configuration having a reflected plate 301 with an edge, a base mount 302 separable from and attachable to the reflected plate 301, forming a reusable housing, and a custom insert 303 in a cavity formed by the reflected plate 301 and the base mount 302, the cavity and custom insert 303 configured to position and secure a first blast gauge 304, such as those illustrated in FIGS. 1-2 or one or more other finished, packaged blast gauges or other equipment for testing, etc.

FIG. 3A illustrates a side view of the reflected plate 301 and the base mount 302. In an example, the raw material of one or more of the reflected plate 301 and the base mount 302 can include aluminum or one or more other metals or rigid materials. In an example, the custom insert 303 can be positioned and secured between the reflected plate 301 and the base mount 302, such that an outer top surface of the custom insert 303 or a blast gauge or other equipment is positioned substantially flush with a top surface of the reflected plate 301 in a top opening in the outer top surface of the custom insert, interior to the edge. In an example, the outer top surface of the custom insert 303 or a blast gauge or other equipment being positioned substantially flush with the top surface of the reflected plate 301 can include being positioned flush with or substantially flush (e.g., within several percent of the height or thickness of the custom insert 303, blast gauge, or other equipment, such as ±5%, etc.) or parallel or substantially parallel to the top surface of the reflected plate 301, etc.

FIGS. 3B-3C illustrate side section views of the first modular blast probe 300 parallel and perpendicular to a major axis of the first blast gauge 304 (e.g. front facing and side facing, respectively) and including a threaded mounting plate 305. In certain examples, the base mount 302 and the mounting plate 305 can be a single, combined component. In an example, the custom insert 303 can include a resin core molded to retain a blast gauge or other equipment at a specific position and orientation during testing. The custom insert 303 can have an interior surface having a set of ridges or features and shape to position the blast gauge in a desired orientation with respect to the top surface of the reflected plate 301 (e.g., features of the custom insert 303 surrounding the first blast gauge 304, etc.). In certain examples, a cushioning layer 306 extending along at least a portion or all of a bottom of the cavity, between a lower surface of the custom insert 303 and the base mount 302, such as sorbothane or one or more other cushioned material, vibration dampener, or shock absorber, to secure the fit of the custom insert, taking up any space between the custom insert 303 and the reflected plate 301 once the reflected plate 301 is attached to the base mount 302, and reduce vibration of the first blast gauge 304 incident to impulse noise or shock wave events during testing.

The custom insert 303 can include a custom molded insert optimized for specific blast gauges (e.g., a resin core molded insert, etc.). In other examples, the custom insert 303 can include a custom 3D printed insert optimized for specific blast gauges, or a combination of molded and 3D printed features to secure the first blast gauge 304 between the reflected plate 301 and the base mount 302. For example, one or more secondary insert features, such as a secondary insert piece 307, can be included to secure the first blast gauge 304 in the custom insert 303, such as by a compression fit, etc., and reduce vibration of the first blast gauge 304 incident to impulse noise or shock wave events during testing.

Although illustrated herein as being custom fit to the first blast gauge 304, in certain examples, the custom insert 303 can be shaped to position and secure different blast gauges having different exterior profiles and shapes in the cavity of the first modular blast probe 300. In one example, the custom insert 303 can be rotated in the cavity of the first modular blast probe 300 in any position (e.g., 360 degrees within the round sidewalls of the cavity). In other examples, one or more mechanical features in the cavity, such as in the base mount 302 or the reflected plate 301, can be configured to interact with the custom insert 303 such that the custom insert 303 can only be placed in the cavity in one or more specific positions. In certain examples, the custom insert 303 can be designed to hold the first blast gauge 304 in the cavity of the first modular blast probe 300 in a first position (e.g., a first angle or degree with respect to a reference point in the round or substantially round sidewalls of the cavity, etc.), and a second blast gauge having a different outer shape or profile than the first blast gauge 304 in a second position (e.g., 90 or 180 degrees from the first position, etc.), while retaining placement and orientation of the respective blast gauge with respect to the first modular blast probe 300, such as described herein. In other examples, the cavity of the first modular blast probe 300 can be configured to receive and retain any number of different custom inserts, such as selectively receiving and retaining a first custom insert at a first time and receiving and retaining a second custom insert at a second time.

In other examples, the custom insert 303 can be configured to hold the first blast gauge 304 as well as a second sensing element (e.g., a pressure sensor) separate from the first blast gauge 304, such that the first modular blast probe 300 can retain both the first blast gauge 304 and a reference sensor at the surface of the first modular blast probe 300.

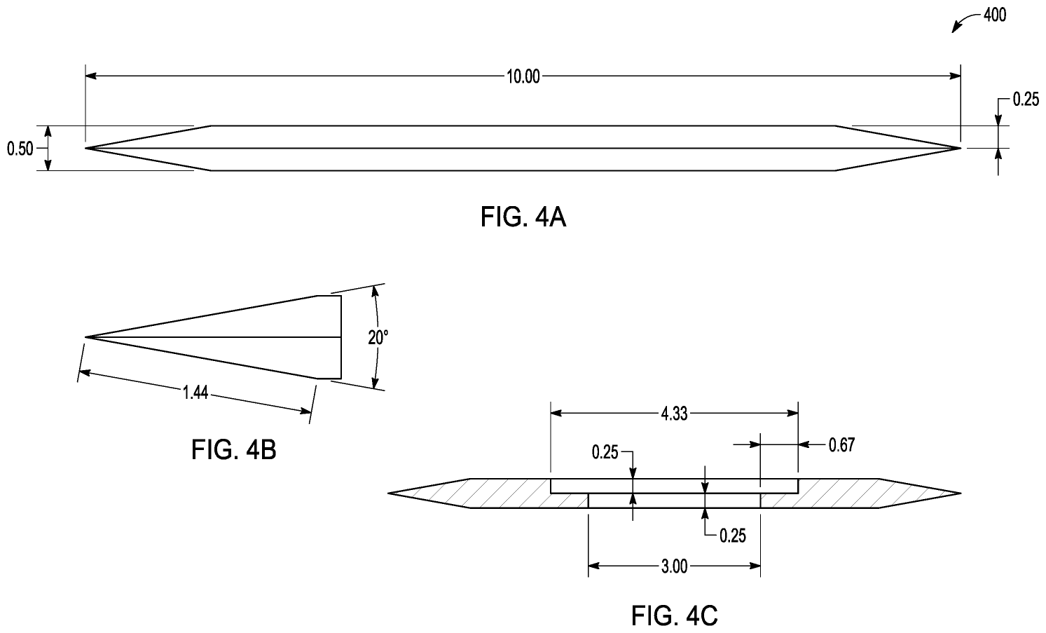

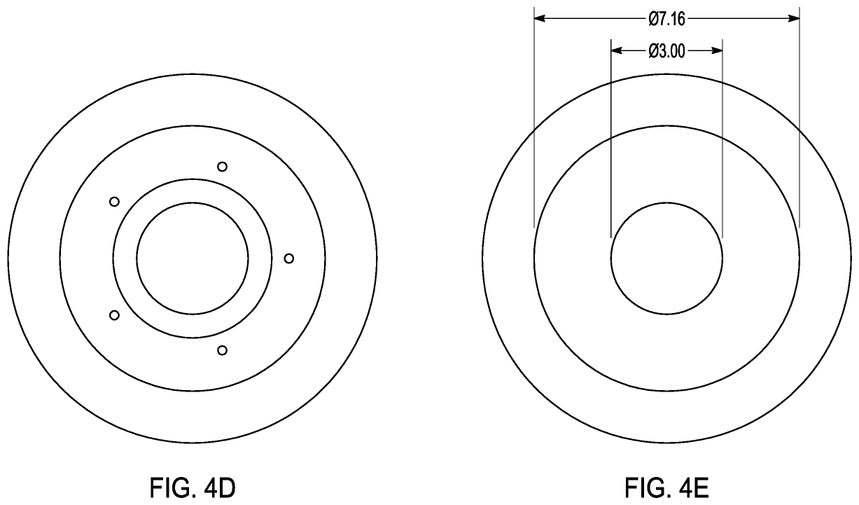

FIGS. 4A-4E illustrate different schematic views of a reflected plate 400, including example dimensions of the reflected plate 301 illustrated in FIGS. 3A-3C, having a circular outer circumference. In certain examples, the reflected plate 301, 400 can be referred to as a wave shaping plate. In a first configuration, with a major axis across the outer diameter parallel to a wave, the reflected plate 301, 400 is configured to allow the wave to break and travel along a top surface without turbulence (e.g., laminar flow) and without attenuating the wave by interacting with it, such that the first blast gauge 304 contained therein can accurately measure the incident overpressure. In a second configuration, with the major axis across the outer diameter perpendicular to the wave (e.g., the top surface facing the wave), the reflected plate 301, 400 is configured to act as a reflecting plate, allowing the first blast gauge 304 to accurately measure a reflected pressure of the wave.

FIG. 4A illustrates a cross section of the reflected plate 400 having an outer diameter (10.00 inches (round)) and a thickness (0.50 inches), with each half above and below the major axis having an equal thickness (0.25 inches). FIG. 4B illustrates an edge angle (20 degrees) and length (1.44 inches) of the edge of the reflected plate 400, surrounding substantially flat top and bottom surfaces (absent top and bottom openings). In certain examples, the edge and top surface of the reflected plate 400 provide a wave-shaping function for data capture and measurement of incident overpressure, such as from a blast (e.g., a test blast, etc.).

FIG. 4C illustrates a top opening (3.00 inches in diameter) in the top surface of the reflected plate 400 and a bottom opening (4.33 inches in diameter) in the bottom surface, leaving a lip (0.67 inches) surrounding the top opening between the top and bottom surfaces at a depth (0.25 inches) to retain the custom insert once the reflected plate 400 is attached to the base mount.

FIGS. 4D and 4E illustrate bottom and top views of the reflected plate 400. FIG. 4D illustrates the bottom view of the reflected plate 400. FIG. 4E illustrates the top view of the reflected plate 400.

The outer-most circle in FIGS. 4D and 4E is the outer diameter (e.g., 10.00 inches) of the reflected plate 400. Moving inside, the second circle is the transition from the edge of the reflected plate 400 (07.16 inches) to the substantially flat bottom surface (absent top and bottom openings). The third circle illustrated in FIG. 4D is the outer boundary of the internal diameter (bottom opening) of the bottom surface (4.33 inches). The small openings (five openings) illustrated in FIG. 4D between the second and third circles are attachment points (e.g., threaded openings) to attach the base mount to the reflected plate 400. The fourth circle is the top opening of the top surface (03.00 inches in diameter). Accordingly, the first modular blast probe 300 illustrated in FIGS. 3A-3C with the dimensions described in FIGS. 4A-4E can be configured to position a blast gauge having a longest length consistent at the top surface limited by the top opening of the top surface of the reflected plate 400, and a thickness limited by the depth of the cavity formed by the reflected plate 400 and an associated base mount.

Although illustrated herein as having specific dimensions, such dimensions are illustrative. In other examples, other dimensions or numbers or placements of features can be used similar to and consistent with that illustrated and described herein, such as to accommodate larger blast sensors or equipment, etc. For example, the outer diameter of the reflected plate can be at least 8.0 inches (e.g., 10.0 inches), the top opening of the reflected plate can be at least 2.0 inches (e.g., 3 inches, and the bottom opening of the reflected plate can be at least 3 inches (e.g., 4.33 inches).

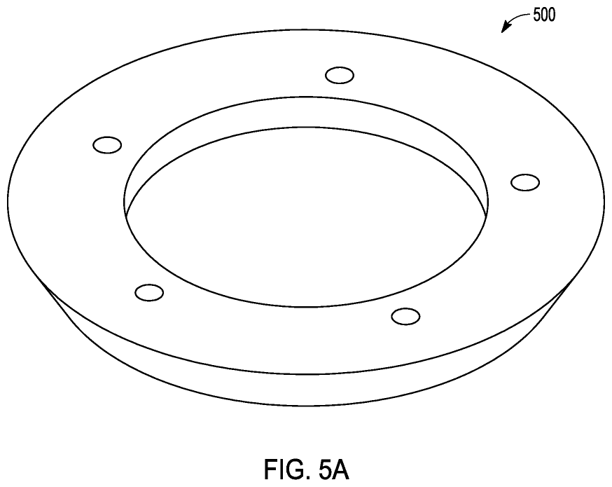

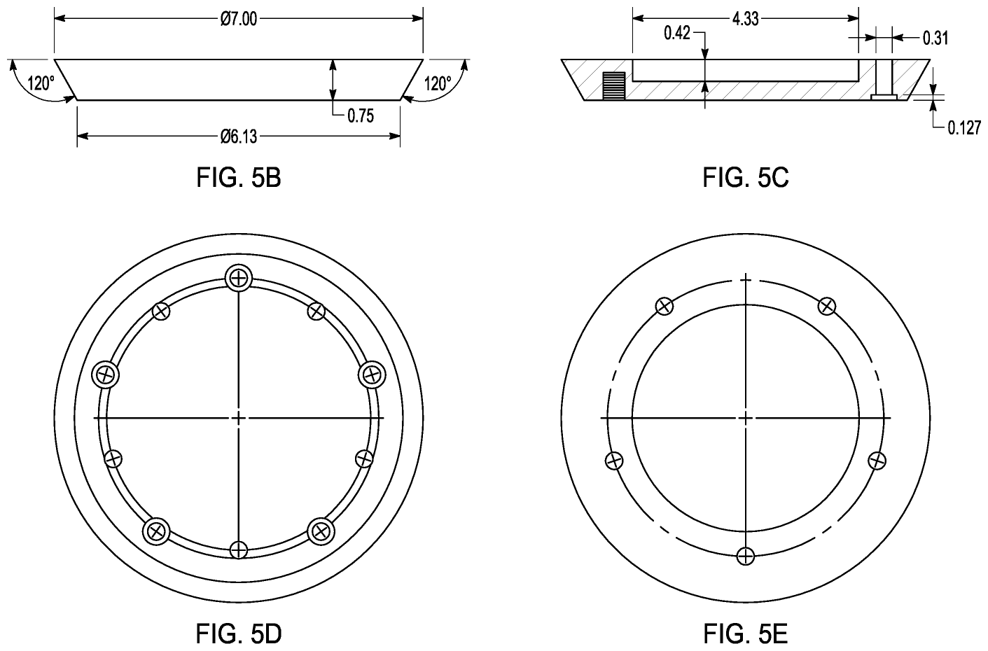

FIGS. 5A-5E illustrate example schematic views of a base mount 500, including example dimensions of the base mount 302 illustrated in FIGS. 3A-3C. FIG. 5A illustrates a perspective view of the base mount 500 having an outer diameter (07.00 inches) and an opening in a top surface of the base mount 500 having a diameter (4.33 inches). FIGS. 5B and 5C illustrate that the base mount 500 has a thickness (0.75 inches), an exterior angle (120 degrees), and a lower diameter (06.13 inches). The opening in the top surface has a depth (0.42 inches), with attachment points into and through a bottom surface of the base mount 500 to attach the base mount 500 to the reflected plate and an additional lower attachment feature, such as the threaded mounting plate 305 illustrated in FIG. 3C, respectively. FIGS. 5D and 5E further illustrate example positions of attachment features for the bottom and top surfaces of the base mount 500 respectively.

The combination of openings in the reflected plate 400 and the base mount 500 illustrated in FIGS. 4A-4D and 5A-5E are configured to position and secure the custom insert in the formed cavity between the reflected plate 400 and the base mount 500, respectively, when the reflected plate 400 and the base mount 500 are coupled or secured together, such as using one or more retention features (e.g., fasteners, screws, bolts, etc.). The opening and internal diameters and depths of the reflected plate 400 and the base mount 500 determine the range of size of sensors capable of being tested by the modular blast probe described herein. In an example, the opening diameter of the reflected plat may be reduced, such as to 2 inches, as well as the remaining dimensions, and still contain the blast gauge illustrated in FIGS. 1-2. In other examples, the reflected plate 400 and the base mount 500 can include other dimensions, depending on the size of the blast gauge or other equipment desired for testing by the reflected plate 400 and the base mount 500.

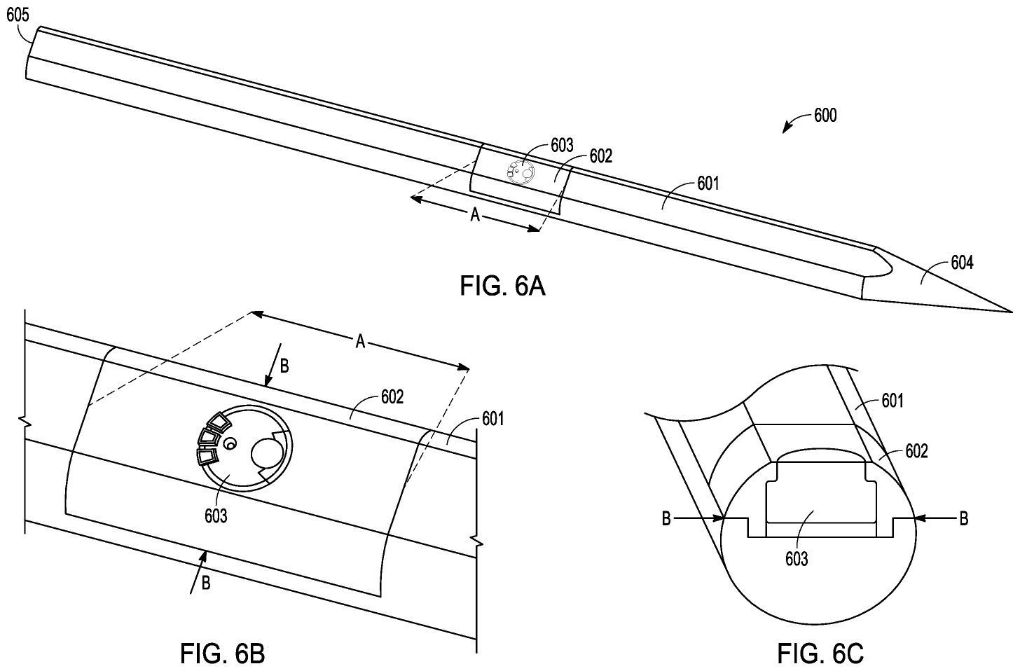

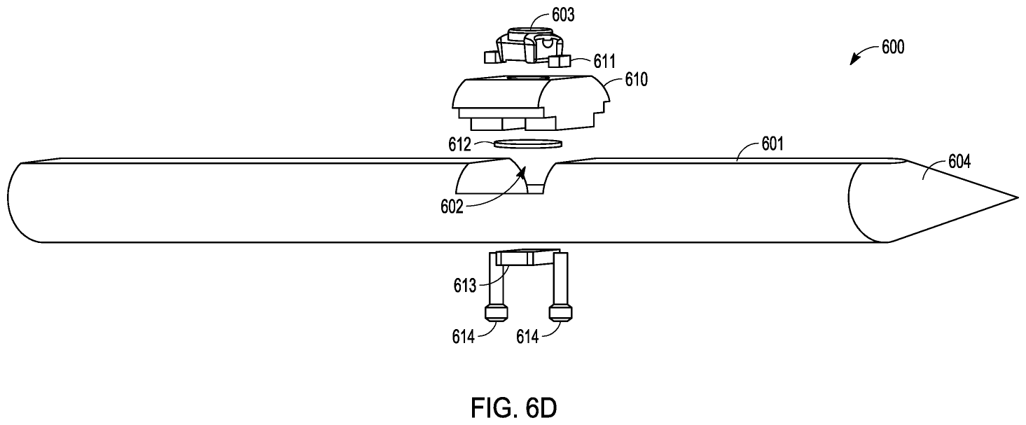

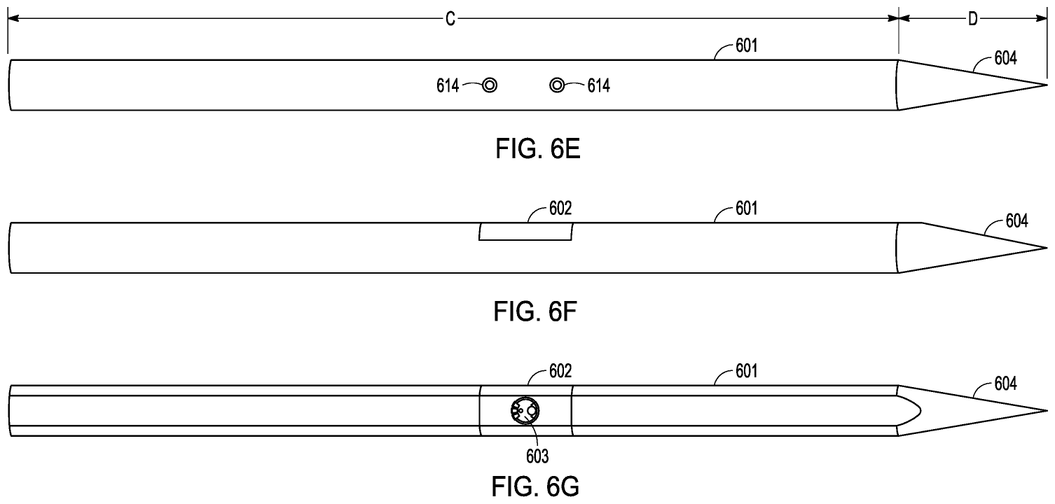

FIGS. 6A-6G illustrate different views of a second modular blast probe 600 in a “pencil” configuration having a body 601 comprising an opening configured to receive a custom insert 602 configured to position and secure a second blast gauge 603, such as those illustrated in FIGS. 1-2 or one or more other finished, packaged blast gauges or other equipment for testing. The body 601 comprises an elongate tube shape (e.g., cylindrical) with an outer surface having a substantially round cross section (substantially round with a relatively smaller flat top surface extending along a majority of the length) perpendicular to a major axis extending between a first tapered end 604 (e.g., a pencil tip) and a blunt second end 605. The remaining portion of the body 601 includes the opening, between the first tapered end 604 and the blunt second end 605 (e.g., mid-way), to receive the custom insert 602. In certain examples, the first tapered end 604 and the relatively smaller flat top surface of the body 601 provide a wave-shaping function for data capture and measurement of incident and reflected forces, such as from a blast (e.g., a test blast, etc.).

FIG. 6A illustrates a perspective view of the second modular blast probe 600 including the custom insert 602 having a length (length A) and the second blast gauge 603. FIG. 6B illustrates a perspective view of a segment of the body 601 of the second modular blast probe 600 (along length A), showing a width (width B) of the custom insert 602. FIG. 6C illustrates a section view (along width B) of the segment of the body 601 of the second modular blast probe 600 illustrated in FIG. 6B, including a rough cross section of the second blast gauge 603 and, in certain examples, a material (e.g., a cushion material) between the second blast gauge 603 and the body 601. FIG. 6C additionally shows interior surface features or a shape of the custom insert 602 to position the second blast gauge 603 in a desired orientation with respect to the top surface of the body 601 (e.g., features of the custom insert 602 surrounding the second blast gauge 603, etc.).

FIG. 6D illustrates an exploded view of the second modular blast probe 600 comprising the second blast gauge 603 and different components of the custom insert 602, including a bottom piece 613 and retention features 614 (e.g., fasteners, screws, bolts, etc.) with respect to the body 601 and the opening. The different components of the custom insert 602 include a custom molded insert 610, one or more secondary insert pieces 611 to fill space between the custom molded insert 610 or retain the second blast gauge 603 in the custom molded insert 610, and a cushioning layer 612 between a surface of the opening and the second blast gauge 603 or the custom molded insert 610.

In certain examples, the custom insert 602 can be held in place with respect to the second modular blast probe 600 with the bottom piece 613 and retention features 614. In an example the retention features 614 can be threaded into the custom molded insert 610. In other examples, one or more of the secondary insert pieces 611 can include threaded connectors configured to engage one or more of the retention features 614.

In an example, the custom molded insert 610 can be specifically designed to position and retain the second blast gauge 603 in a desired orientation with respect to the body 601 of the second modular blast probe 600, such as with a top surface of the second blast gauge 603 flush with an outer surface of the body 601, etc. In other examples, the custom molded insert 610 can be designed to position and retain the second blast gauge 603 as well as one or more other blast gauges or other equipment, such as using different secondary insert pieces 611 to position and retain the different blast gauges or other equipment in the desired orientation.

FIGS. 6E-6G illustrate bottom, side, and top views of the second modular blast probe 600, respectively. In an example, the body 601 of the second modular blast probe 600 has a total length (45.8 inches) as a combination of a length D of the first tapered end 604 (6.4421 inches) and a length C of the remaining portion of the body 601 (39.4 inches), having a diameter (2.333 inches).

The size of the second blast gauge 603 available for testing is limited by the dimension of the custom insert 602, which is limited by the dimensions of the body 601 of the second modular blast probe 600. Although illustrated herein as having specific dimensions, such dimensions are illustrative. In an example, the overall length of the second modular blast probe 600 may be reduced, such as to 30 inches, as well as the remaining dimensions, and still contain the blast gauge illustrated in FIGS. 1-2.

In other examples, other dimensions or numbers or placements of features can be used similar to and consistent with that illustrated and described herein, such as to accommodate larger or smaller blast sensors or equipment, etc. For example, the overall length along the major axis of the second modular blast probe can be greater than 24.0 inches (e.g., 45.8 inches), and the diameter of the remaining portion of the body (e.g., having a substantially round cross section along the major axis) can be at least 2.0 inches (e.g., 2.333 inches), or between 2.0 and 3.0 inches, etc.

In other examples, the custom insert 602 can be configured to hold the second blast gauge 603 as well as a sensing element (e.g., a pressure sensor) separate from the second blast gauge 603, such that the second modular blast probe 600 can retain both the second blast gauge 603 and a reference sensor at the surface of the second modular blast probe 600.

Although illustrated in FIGS. 3A-3C, 4A-4E, 5A-5D, and 6A-6G as having an opening configured to receive and secure custom inserts, in other examples, the housings of the first and second modular blast probes 300, 600 themselves can be configured to position and secure the first or second blast gauges 304, 603 or one or more other finished, packaged blast gauges or other equipment for testing, etc., omitting the custom inserts 303, 602 as separate components and incorporating their features into the respective housings (e.g., the reflected plate 301, the base mount 302, the body 601, etc.). For example, without the custom inserts 303, 602, the openings in the top surface of the reflected plate 301 of the first modular blast probe 300 and the body 601 of the second modular blast probe 600 can be as small as 5 mm when used to secure a lab-grade commercial off-the-shelf pressure sensor, or slightly larger (e.g., 10 mm, etc.) to retain an insert to receive a sensor, etc. Additionally, in certain examples, the reflected plate 301 and the base mount 302, and in certain examples additionally the threaded mounting plate 305, can be a single, combined component.

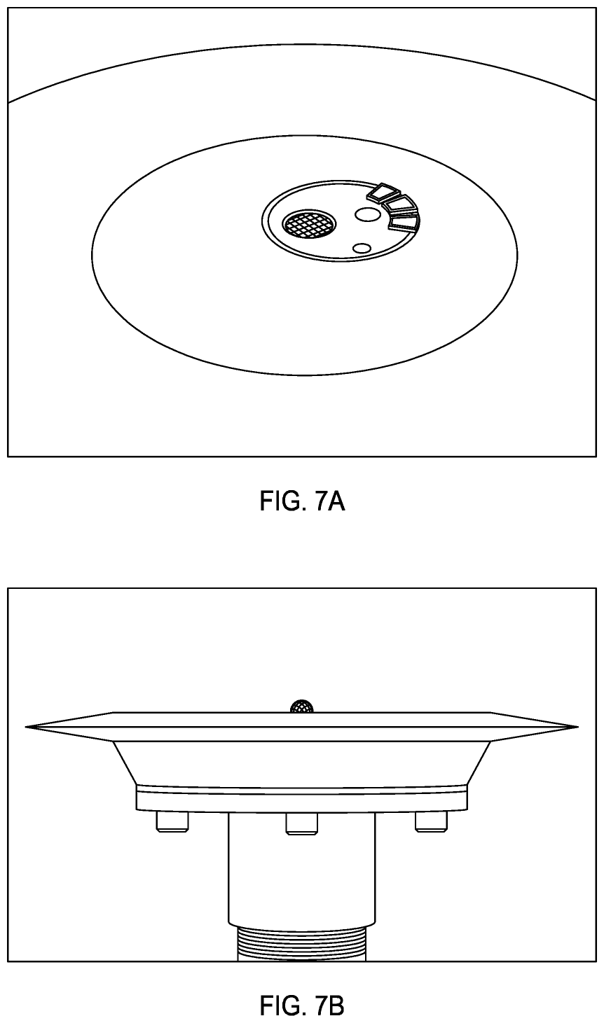

FIGS. 7A-7B illustrate example top perspective and side views of the first modular blast probe in operation, including a first blast gauge having a flat sensor cover in FIG. 7A and a second blast gauge having a domed sensor cover in FIG. 7B. The flat and domed sensor covers each cover a top opening in the respective top surface of the housing of the respective blast gauge, the top openings over respective sensing elements configured to be protected and covered by the respective sensor covers. The first blast gauge in FIG. 7A is shown held off-center with respect to the custom insert. However, the sensor cover covering the sensing element is shown near the center of the first modular blast probe. Similarly, the side view of FIG. 7B shows the domed sensor cover of the second blast gauge at or near the center of the first modular blast probe. Additionally, the threaded mounting plate 305 illustrated in FIG. 3C is shown in FIG. 7B threaded onto a threaded pole, with fastening elements to attach the threaded mounting plate 305 to the base mount 302.

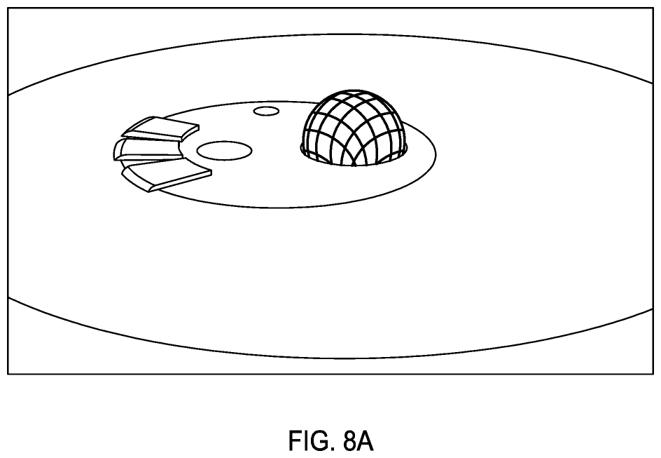

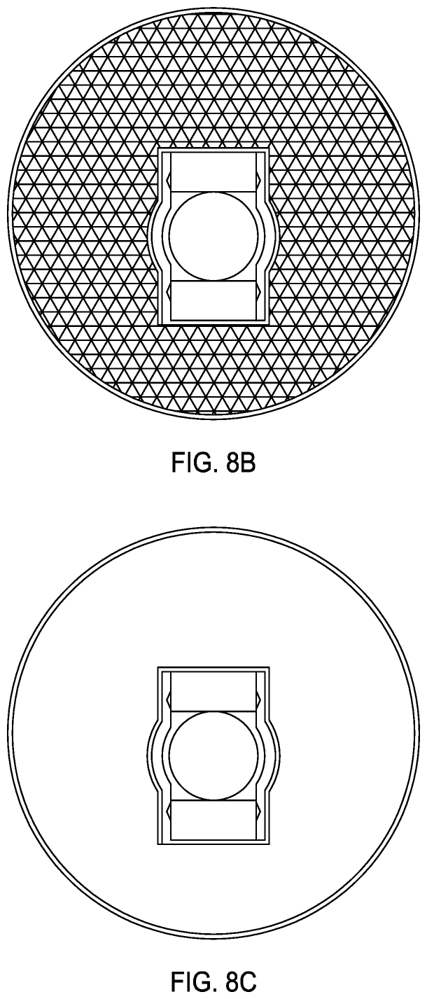

FIGS. 8A-8C illustrate example views of different example custom molds and inserts. FIG. 8A illustrates a top perspective view of the second blast gauge having a domed sensor cover positioned and secured, flush with a top surface of the first modular blast probe by a custom insert having a finished, resin core. FIGS. 8B-8C illustrate different molded inserts, including a 3D printed custom molded insert in FIG. 8B, such as for use in producing a custom insert, such as by a cured resin core.

Although the first modular blast probe having the lollipop configuration illustrated herein comprises two portions configured to surround the custom insert and the blast gauge, and the second modular blast probe comprising the pencil configuration illustrated herein comprises one main portion and a custom insert inserted into an opening and secured to the opening using retention features, in other examples, the first modular blast probe can include a single main portion with the custom insert inserted into an opening and secured using retention features, and the second modular blast probe can include two or more portions configured to surround the custom insert and the blast gauge. In other examples, other configurations and attachment of the custom insert to the first or second modular blast probes can be used, so long as the custom insert contains the finished, packaged blast gauge and positions the sensing element of the finished, packaged blast gauge flush (or substantially flush) with the outer surface of the modular blast probe.

Various embodiments are illustrated in the figures above. One or more features from one or more of these embodiments may be combined to form other embodiments. Method examples described herein can be machine or computer-implemented at least in part. Some examples may include a computer-readable medium or machine-readable medium encoded with instructions operable to configure an electronic device or system to perform methods as described in the above examples. In other examples, one or more wires can directly couple circuits to the sensing elements, blast gauges, or other equipment under test, such as through the center of the first modular blast probe or through the blunt second end of the second modular blast probe. An implementation of such methods can include code, such as microcode, assembly language code, a higher-level language code, or the like. Such code can include computer readable instructions for performing various methods. The code can form portions of computer program products. Further, the code can be tangibly stored on one or more volatile or non-volatile computer-readable media during execution or at other times.

An example (e.g., “Example 1”) of subject matter (e.g., a system) may include a reusable housing having a cavity and an outer surface to provide a wave-shaping function and a first insert configured for placement in the cavity of the reusable housing, wherein the cavity of the reusable housing is configured to receive and retain the first insert, the first insert includes an interior surface configured to engage and position a top surface of a housing of a first blast gauge substantially flush with an outer top surface of the first insert, and the outer top surface of the first insert, when positioned into and retained in the cavity of the reusable housing, is substantially flush with the outer surface of the reusable housing.

In Example 2, the subject matter of Example 1 may optionally include retention features to secure the first insert in the cavity of the reusable housing.

In Example 3, the subject matter of any one or more of Examples 1-2 may optionally be configured such that the interior surface of the first insert is configured to engage and position, at different times, the first blast gauge and a second blast gauge, different than the first blast gauge.

In Example 4, the subject matter of any one or more of Examples 1-3 may optionally be configured such that the interior surface of the first insert is configured to engage and position the top surface of the housing of the first blast gauge substantially flush with the outer top surface of the first insert using first features of the interior surface and the interior surface of the first insert is configured to engage and position a top surface of a housing of a second blast gauge substantially flush with the outer top surface of the first insert using second features of the interior surface.

In Example 5, the subject matter of any one or more of Examples 1-4 may include a second insert, different from the first insert, configured for placement in the cavity of the reusable housing at a different time as the first insert, wherein the second insert includes an interior surface configured to engage and position a top surface of a housing of a second blast gauge substantially flush with an outer top surface of the second insert, the cavity of the reusable housing is configured to selectively receive and retain, at different times, the first insert and the second insert, and the outer top surface of the second insert, when positioned into and retained in the cavity of the reusable housing, is substantially flush with the outer surface of the reusable housing.

In Example 6, the subject matter of any one or more of Examples 1-5 may include the first blast gauge, wherein the first blast gauge comprises electronic circuitry and a battery inside the housing, an indicator light and at the top surface of the housing, and a top opening proximate a sensing element of the first blast gauge at the top surface of the housing and the first insert, when positioned into and retained in the cavity of the reusable housing, is configured to position the top opening of the first blast gauge substantially flush with the outer surface of the reusable housing.

In Example 7, the subject matter of any one or more of Examples 1-6 may optionally be configured such that the first insert and the cavity are cylindrical and the interior surface of the first insert is configured to center the top opening of the first blast gauge at the outer top surface of the first insert with respect to axes through centers of the cavity and the first insert.

In Example 8, the subject matter of any one or more of Examples 1-7 may optionally be configured such that the reusable housing comprises a top surface having a round cross section parallel with a major axis of the reusable housing.

In Example 9, the subject matter of any one or more of Examples 1-8 may optionally be configured such that the reusable housing includes a lollipop configuration configured to support data capture of incident and reflected measurements of test blasts proximate the reusable housing and the outer surface of the reusable housing comprises a circular outer circumference, wherein the major axis of the reusable housing is across a diameter of the circular outer circumference.

In Example 10, the subject matter of any one or more of Examples 1-9 may optionally be configured such that the reusable housing comprises a reflected plate and a base mount, the reflected plate comprises an edge, a top surface, and a circular outer circumference around the edge, and the edge and the top surface provide the wave-shaping function of the reusable housing in respective incident and reflected measurements of test blasts proximate the reusable housing.

In Example 11, the subject matter of any one or more of Examples 1-10 may optionally be configured such that a top surface of the base mount is configured to couple to a bottom surface of the reflected plate, forming the cavity of the reusable housing.

In Example 12, the subject matter of any one or more of Examples 1-11 may optionally be configured such that the reflected plate comprises a top opening in the top surface of the reflected plate and a bottom opening in a bottom surface of the reflected plate, the bottom opening larger than the top opening, the base mount comprises an opening in a top surface matching the bottom opening in the bottom surface of the reflected plate, and the openings in the top surface of the base mount and the top and bottom openings in the reflected plate, when the base mount and the reflected plate are coupled together, form the cavity of the reusable housing.

In Example 13, the subject matter of any one or more of Examples 1-12 may optionally be configured such that the reflected plate and the base mount, when coupled together forming the cavity and retaining the first insert, are configured to position and secure the first insert in the modular blast probe and the cavity is cylindrical with a bottom and sidewalls, wherein the sidewalls are parallel to the circular outer circumference of the reusable housing.

In Example 14, the subject matter of any one or more of Examples 1-13 may optionally be configured such that the reflected plate has a diameter of at least 8 inches, the top opening of the reflected plate is at least 2 inches in diameter, and the bottom opening of the reflected plate and the opening in the top surface of the base mount are at least 3 inches in diameter.

In Example 15, the subject matter of any one or more of Examples 1-14 may optionally be configured such that the reflected plate has a diameter of 10 inches, the top opening of the reflected plate is 3 inches in diameter, and the bottom opening of the reflected plate and the opening in the top surface of the base mount are 4.33 inches in diameter

In Example 16, the subject matter of any one or more of Examples 1-15 may optionally be configured such that the first insert and the cavity are cylindrical, and wherein the interior surface of the first insert is configured to position the housing of the first blast gauge off-center with respect to axes through centers of the cavity and the first insert.

In Example 17, the subject matter of any one or more of Examples 1-16 may optionally be configured such that the outer surface of the reusable housing has a substantially round cross section perpendicular with a major axis of the reusable housing.

In Example 18, the subject matter of any one or more of Examples 1-17 may optionally be configured such that the reusable housing includes a pencil configuration configured to support data capture of incident measurements of test blasts proximate the reusable housing and the pencil configuration includes a first tapered end and a second blunt end at opposite ends of the major axis.

In Example 19, the subject matter of any one or more of Examples 1-18 may optionally be configured such that the outer surface has a length along the major axis of at least 24 inches, wherein the substantially round cross section has a diameter between 2 and 3 inches.

In Example 20, the subject matter of any one or more of Examples 1-19 may optionally be configured such that the outer surface has a length along the major axis of 45.8 inches, wherein the substantially round cross section has a diameter of 2.33 inches.

An example (e.g., “Example 21”) of subject matter (e.g., a system) may include a modular blast probe including a reusable housing having a cavity and an outer surface to provide a wave-shaping function and a first blast gauge comprising a top surface having a top opening proximate a sensing element, wherein the cavity of the reusable housing is configured to receive and retain the first blast gauge and the reusable housing includes an interior surface configured to engage the first blast gauge and to position the top surface of the first blast gauge substantially flush with the outer surface of the reusable housing.

In Example 22, subject matter (e.g., a system or apparatus) may optionally combine any portion or combination of any portion of any one or more of Examples 1-21 to comprise “means for” performing any portion of any one or more of the functions or methods of Examples 1-21, or at least one “non-transitory machine-readable medium” including instructions that, when performed by a machine, cause the machine to perform any portion of any one or more of the functions or methods of Examples 1-21.

The above detailed description is intended to be illustrative, and not restrictive. The scope of the disclosure should, therefore, be determined with references to the appended claims, along with the full scope of equivalents to which such claims are entitled.

What is claimed is:

1. A modular blast probe, comprising:
a reusable housing having a cavity and an outer surface to provide a wave-shaping function; and
a first insert configured for placement in the cavity of the reusable housing,
wherein the cavity of the reusable housing is configured to receive and retain the first insert,
wherein the first insert includes an interior surface configured to engage and position a top surface of a housing of a first blast gauge substantially parallel to an outer top surface of the first insert, and
wherein the outer top surface of the first insert, when positioned into and retained in the cavity of the reusable housing, is substantially flush with the outer surface of the reusable housing.

2. The modular blast probe of claim 1, comprising:
retention features to secure the first insert in the cavity of the reusable housing.

3. The modular blast probe of claim 1, wherein the interior surface of the first insert is configured to engage and position, at different times, the first blast gauge and a second sensing element, separate from the first blast gauge.

4. The modular blast probe of claim 3, wherein the interior surface of the first insert is configured to engage and position the top surface of the housing of the first blast gauge substantially flush with the outer top surface of the first insert using first features of the interior surface, and
wherein the interior surface of the first insert is configured to engage and position a top surface of a housing of a second blast gauge substantially flush with the outer top surface of the first insert using second features of the interior surface.

5. The modular blast probe of claim 1, comprising:
a second insert, different from the first insert, configured for placement in the cavity of the reusable housing at a different time as the first insert,
wherein the second insert includes an interior surface configured to engage and position a top surface of a housing of a second blast gauge substantially flush with an outer top surface of the second insert,
wherein the cavity of the reusable housing is configured to selectively receive and retain, at different times, the first insert and the second insert, and
wherein the outer top surface of the second insert, when positioned into and retained in the cavity of the reusable housing, is substantially flush with the outer surface of the reusable housing.

6. The modular blast probe of claim 1, comprising:
the first blast gauge,
wherein the first blast gauge comprises electronic circuitry and a battery inside the housing, an indicator light and at the top surface of the housing, and a top opening proximate a sensing element of the first blast gauge at the top surface of the housing, and
wherein the first insert, when positioned into and retained in the cavity of the reusable housing, is configured to position the top opening of the first blast gauge substantially flush with the outer surface of the reusable housing.

7. The modular blast probe of claim 6, wherein the first insert and the cavity are cylindrical, and
wherein the interior surface of the first insert is configured to center the top opening of the first blast gauge at the outer top surface of the first insert with respect to axes through centers of the cavity and the first insert.

8. The modular blast probe of claim 1, wherein the reusable housing comprises a top surface having a round cross section parallel with a major axis of the reusable housing.

9. The modular blast probe of claim 8, wherein the reusable housing includes a lollipop configuration configured to support data capture of incident and reflected measurements of test blasts proximate the reusable housing, and
wherein the outer surface of the reusable housing comprises a circular outer circumference, wherein the major axis of the reusable housing is across a diameter of the circular outer circumference.

10. The modular blast probe of claim 1, wherein the reusable housing comprises a reflected plate and a base mount,
wherein the reflected plate comprises an edge, a top surface, and a circular outer circumference around the edge, and
wherein the edge and the top surface provide the wave-shaping function of the reusable housing in respective incident and reflected measurements of test blasts proximate the reusable housing.

11. The modular blast probe of claim 10, wherein a top surface of the base mount is configured to couple to a bottom surface of the reflected plate, forming the cavity of the reusable housing.

12. The modular blast probe of claim 10, wherein the reflected plate comprises a top opening in the top surface of the reflected plate and a bottom opening in a bottom surface of the reflected plate, the bottom opening larger than the top opening,
wherein the base mount comprises an opening in a top surface matching the bottom opening in the bottom surface of the reflected plate, and
wherein the openings in the top surface of the base mount and the top and bottom openings in the reflected plate, when the base mount and the reflected plate are coupled together, form the cavity of the reusable housing.

13. The modular blast probe of claim 12, wherein the reflected plate and the base mount, when coupled together forming the cavity and retaining the first insert, are configured to position and secure the first insert in the modular blast probe, and
wherein the cavity is cylindrical with a bottom and sidewalls, wherein the sidewalls are parallel to the circular outer circumference of the reusable housing.

14. The modular blast probe of claim 13, wherein the reflected plate has a diameter of at least 8 inches,
wherein the top opening of the reflected plate is at least 2 inches in diameter, and
wherein the bottom opening of the reflected plate and the opening in the top surface of the base mount are at least 3 inches in diameter.

15. The modular blast probe of claim 13, wherein the reflected plate has a diameter of 10 inches,
wherein the top opening of the reflected plate is 3 inches in diameter, and
wherein the bottom opening of the reflected plate and the opening in the top surface of the base mount are 4.33 inches in diameter.

16. The modular blast probe of claim 1, wherein the first insert and the cavity are cylindrical, and wherein the interior surface of the first insert is configured to position the housing of the first blast gauge off-center with respect to axes through centers of the cavity and the first insert.

17. The modular blast probe of claim 1, wherein the outer surface of the reusable housing has a substantially round cross section perpendicular with a major axis of the reusable housing.

18. The modular blast probe of claim 17, wherein the reusable housing includes a pencil configuration configured to support data capture of incident measurements of test blasts proximate the reusable housing, and
wherein the pencil configuration includes a first tapered end and a second blunt end at opposite ends of the major axis.

19. The modular blast probe of claim 18, wherein the outer surface has a length along the major axis of at least 24 inches, wherein the substantially round cross section has a diameter between 2 and 3 inches.

20. The modular blast probe of claim 18, wherein the outer surface has a length along the major axis of 45.8 inches, wherein the substantially round cross section has a diameter of 2.33 inches.

21. A modular blast probe, comprising:
a reusable housing having a cavity and an outer surface to provide a wave-shaping function; and
a first blast gauge comprising a top surface having a top opening proximate a sensing element,
wherein the cavity of the reusable housing is configured to receive and retain the first blast gauge, and
wherein the reusable housing includes an interior surface configured to engage the first blast gauge and to position the top surface of the first blast gauge substantially flush with the outer surface of the reusable housing.
